(19) United States
(12) Patent Application Publication
(10) Pub. No.: US 2018/0237674 A1
(43) Pub. Date: Aug. 23, 2018

(54) SEALANT FOR A CONCRETE ELEMENT AND METHOD FOR PRODUCING A SEALANT

(71) Applicant: CEMproof Group GmbH, Herrenberg (DE)

(72) Inventor: ADRIAN PFLIEGER, HERRENBERG (DE)

(73) Assignee: CEMproof Group GmbH, Herrenberg (DE)

(21) Appl. No.: 15/880,144

(22) Filed: Jan. 25, 2018

(30) Foreign Application Priority Data
Feb. 17, 2017 (EP) 17156627.6

(51) Int. Cl. C09K 3/10; C04B 41/50; C04B 41/45

(52) U.S. Cl. CPC C09K 3/10; C04B 41/5024; C04B 41/4596; C09K 2003/1081; C04B 41/4505; C04B 41/501; C09K 2003/104; C04B 41/5098

(57) ABSTRACT

A sealant for a concrete element, having a planar carrier and an active substance applied onto the carrier, wherein the active substance is designed to be chemically reactive with water. The carrier is flexible.

### CROSS-REFERENCE TO RELATED APPLICATIONS

This application claims priority under 35 USC 119 of European Patent Application No. 17156627.6, filed Feb. 17, 2017, the disclosure of which is herein incorporated by reference.

### BACKGROUND OF THE INVENTION

The invention relates to a sealant for a concrete element, comprising a planar carrier and an active substance applied onto the carrier, wherein the active substance is designed to be chemically reactive with water.

Buildings are being designed more and more nowadays as water-impermeable concrete structures.

To this end, it is known in the related art to seal joints, cracks, and the like in a concrete element by means of subsequent crack injections. Each crack must be treated individually in this case, however. In addition, regular inspections are required in order to search for and treat any new cracks that may have developed.

Alternatively, so-called fresh concrete composite films are utilized for the planar sealing of a concrete element. These fresh concrete composite films are applied onto the concrete element to be sealed. They achieve their sealing effect by way of an integrated film which is made, for example, of PVC or PE.

It is disadvantageous in this case that moisture can no longer reach the concrete element once such a fresh concrete composite film has been applied. In particular, a rehydration, which is desirable in principle, is therefore prevented. If the fresh concrete composite film becomes damaged over the course of time, or if it begins to tear due to aging, the protective effect of the film is lost over a large area.

EP 0 992 466 B1 describes a sealing element which comprises a water-repellent admixture instead of an active substance applied onto the carrier. The water-repellent admixture can be physically dissolved in alkaline media, so that a (water-swellable) active substance can begin to swell.

EP 1 571 271 B2 describes a sealing device for sealing work joints, in which the carrier is designed as a galvanized carrier sheet and is therefore rigid. In order to seal the work joint, the sealing device is introduced into the work joint.

It is also known to embed bentonite, which swells highly upon contact with water, between two geotextiles. Such a sealant is utilized, for example, in landfill construction and acts by allowing moisture to penetrate up to the bentonite over time, so that the bentonite swells and ultimately develops the sealing effect.

### SUMMARY OF THE INVENTION

The problem addressed by the invention is that of improving a sealant for a concrete element of the type in question.

The problem is solved by a sealant for a concrete element, comprising a planar carrier and an active substance applied onto the carrier, wherein the active substance is designed to be chemically reactive with water, and wherein the carrier is flexible.

The active substance can be applied on the carrier so as to be dissolvable from the carrier. In particular, the active substance can be dissolvable from the carrier in an alkaline medium and/or by means of a medium, in particular an alkaline, hydrous medium. In this case, it can be provided that the active substance comprises substances which can be dissolved out of the active substance and have, in particular, a mechanical and/or chemical sealing effect. For example, the active substance can include a limestone-forming substance.

The flexible carrier can be, in particular, not rigid, i.e., inherently movable. The carrier can be inelastically flexible. Since the carrier is flexible, the sealant can be even more easily handled, in particular the sealant can also be situated on concrete elements having an uneven surface. The sealant can therefore be utilized both for sealing joints, in particular work joints, and for sealing, in particular, uneven surfaces of concrete elements. The concrete elements and/or concrete surfaces of the concrete elements can be situated so as to have contact with the earth. They can also be exposed to water.

Since the active substance has been applied onto the flexible carrier, incoming moisture can very easily reach the active substance. The active substance can then chemically react with the moisture. The moisture or water can come, for example, from a concrete edge zone of a freshly prepared concrete element, on which the sealant is situated. The moisture can also come from the surroundings.

The water can be alkaline and/or the active substance can be designed to be chemically reactive with alkaline water.

Properties, in particular sealing properties, of the sealant can therefore also be automatically modified by means of chemical reactions after production or after processing. Such a modification can also extend over a relatively long period of time, and therefore such a modification can also take place continuously. The modifications can also be limited to one or multiple areas of the carrier, in particular depending on the planar distribution of the moisture.

The quantity of incoming moisture can also depend on whether cracks, defective spots, or the like are locally present in the sealant and/or on a concrete element onto which the sealant has been applied.

It can be provided that the sealant is at least slightly water-permeable after the production thereof, in particular before the use thereof for sealing a concrete element.

The water-permeability can be measured on the basis of the permeability coefficient. In particular, the sealant can be at least slightly water-permeable when it has a permeability coefficient of at least 10⁻⁹ m/s.

A particularly favorable sealing effect can be achieved when the permeability coefficient is between 10⁻⁹ m/s and 10⁻⁸ m/s.

The permeability coefficient can also be up to 10⁻⁴ m/s. In this case, active substance can particularly easily reach the concrete element. In particular, the active substance can be actively dissolved out by means of the alkalinity of the concrete element, in particular in the case of fresh concrete. The active substance can then chemically react in and/or on the concrete element.

Therefore, moisture can reach the concrete element through the sealant even after the sealant has been applied onto the concrete element. The concrete element can absorb moisture and, for example, rehydrate. The concrete element, in particular a concrete edge zone of the concrete element, can therefore also reseal.

By way of an initial flow of water or moisture through the sealant, which is deliberate yet is limited by the sealant, active substance can be conveyed from the carrier to the concrete element and, at the concrete element, can support and/or actively initiate a local sealing. The active substance can also play a catalytic role, in particular for the self-sealing of the concrete element.

In this way, in particular, cracks, defective spots, or the like can be sealed locally in the area of a crack or a defective spot or the like. In other words, the sealant can deploy its effect, in particular, where the sealing effect is “required”, since stronger moisture flows also generally occur in these areas. Any cracks in the concrete element can therefore be sealed in the sense of a “self-healing” of the concrete element (and not only of the sealant itself).

In contrast to the fresh concrete composite film described at the outset, the sealant according to the invention can therefore not only act as a moisture barrier or obstacle by itself, but can also actively contribute to an improvement in the tightness of the concrete element itself. Even when the sealant has been locally damaged and, therefore, the water permeability in the area of the damage is increased, the sealing effect can be at least largely retained for the remaining sealed areas and possibly even for the damaged area.

It can also be provided that the sealant changes its water-permeability over the course of time, proceeding from the water-permeability of the sealant which existed after the sealant was produced. In this way, the sealant can be designed, for example, to be self-swelling and, therefore, can reduce its water-permeability over the course of time. If such a sealant is damaged, the damaged area can therefore also be automatically partially or completely eliminated by way of the sealant.

It can be provided that the carrier is designed as a geomembrane, a geotextile, a film and/or a nonwoven fabric, in particular as a PP nonwoven fabric, a PE nonwoven fabric, a PE woven fabric, a PP woven fabric, a nonwoven fabric-woven fabric combination, particularly preferably as a mechanically joined nonwoven fabric-woven fabric combination.

Such geomembranes, geotextiles, and/or nonwoven fabrics are available at low cost and can cover and seal even large concrete elements. Such a carrier can also contribute to the reinforcement, to the post-treatment of the concrete edge zone, and/or to the reduction of pores in the concrete element.

It is also conceivable that the active substance comprises or is a cement, quartz, a silicate, an ash, in particular fly ash, a calcium hydroxide, a carbonate, in particular a hydrogen carbonate, a non-hydrogen carbonate, and/or a calcium carbonate.

Such an active substance can make sealing possible in a chemical, physical and/or mechanical way. In particular, it is possible that a sealing effect can be achieved both by means of the sealant as well as by a concrete element to be sealed.

The active substance can be swelling in order to achieve a physical seal. For example, cement or cement stone contained in the active substance can swell. As a result, the initial water-permeability of the sealant can be reduced, in particular after a defined period of time has elapsed or over a defined period of time. Cement or cement stone contained in the active substance applied on the carrier can also be transported to the concrete element and, at that point, can swell and, for example, locally close cracks or pores in the concrete element.

A chemical sealing effect can be achieved, in particular, by rehydrating cement or cement stone and/or by forming (water-insoluble) calcium carbonate.

A mechanical seal can be achieved by constricting or blocking a flow path by means of anorganic or organic fines, for example quartz silicate or ash. It is understood that other active substances, such as cement, calcium hydroxide, or carbonate, as fines can also deploy a mechanical sealing effect, in particular in a supplementary manner.

A particularly favorable sealing effect can be achieved by means of crystallization or sintering. For this purpose, calcium carbonate, in particular, can be provided in the active substance or can be released by the active substance. The calcium carbonate can deposit on the concrete element, along the flow path of the water, and, there, plug and seal cracks or the like.

Such a mechanical crack closure can be achieved, in particular, in an initial phase by means of such fines or particles.

It is conceivable, in particular, that the active substance contains an adhesion promoter.

The adhesion promoter can be water-insoluble. The adhesion promoter can be soluble in an alkaline medium. It is also conceivable that the adhesion promoter is water-permeable.

The adhesion promoter can be mixed, as a dispersion, into the active substance. In particular, the active substance can include a dispersing phase having an adhesion-promoting effect.

As a result, the active substance can be applied onto the carrier and can adhere thereto in an improved way, thereby making it easier to apply the active substance and subsequently use the sealant, for example at a construction site.

In particular, the active substance can include the adhesion promoter, in particular as a dispersion and/or a dispersing phase, as the first component, and, as a second component, a cement, a calcium hydroxide, and/or a mixture of quartz, a silicate, fly ash, a non-hydrogen carbonate, and a hydrogen carbonate.

In other words, the substance can also contain the adhesion promoter, for example as a plastic dispersion. To this end, the adhesion promoter can be incorporated into the remaining active substance or can be mixed therewith. The subsequent sealing material or the second component can then be easily applied on the carrier and, therefore, at least temporarily fixed. In other words, the active substance can be capable of adhering particularly well. In particular, it can also form a sheet-like unit.

The active substance can include an elasticizer. The elasticizer can be, for example, a plastic-based substance. For example, the elasticizer can be a plastic dispersion and/or a dispersing phase of a plastic dispersion. The elasticizer can be designed, in particular, for reducing the brittleness of at least one other component of the active substance, for example cement, and/or for improving the elasticity thereof. The elasticizer can also be designed for improving the elasticity and/or flexibility of the active substance applied on the carrier.

In general, the active substance can include a type of a dispersing phase. The active substance can also include at least two different types of a dispersing phase. For example, a first type of a dispersing phase can have an adhesion-promoting property and/or can be an adhesion promoter, and a second type of a dispersing phase can have an elasticizing property and/or can be an elasticizer.

In other words, a dispersion, preferably at least two different types of dispersions, can be incorporated into the active substance during production.

The dispersion can be, for example, a latex dispersion or a water-plastic dispersion.

The active substance can include, preferably as a dispersion or in the form of a dispersing phase, vinyl acetate-ethylene, an ethylene-vinyl acetate copolymer and/or vinyl acetate.

The active substance can also include a preferably water-swellable polymer, in particular a liquid dispersion polymer or a superabsorbent polymer. The mass fraction of the polymer with respect to the active substance can be between 40% and 60%, in particular 50%.

The polymer, in particular the liquid dispersion polymer or the superabsorbent polymer, can have a high swelling volume and/or can be adhesion-promoting. The polymer can be incorporated into the active substance in order to produce the active substance as a dispersion. In particular, the polymer can be contained in the active substance as a dispersing phase.

When water flows through, the polymer can therefore swell to a particularly strong extent and reduce the water-permeability of the carrier. As a result, the water flow through the carrier can be reduced, in particular after the active substance or a component of the active substance has washed onto the concrete element. A depositing, sintering, and/or reaction of the active substance or the component on or with the concrete element and, therefore, the local sealing effect, can therefore be further improved.

The polymer itself can also be provided as a carrier. In this case, it can be advantageous, in particular, that the polymer, in particular the liquid dispersion polymer and/or the superabsorbent polymer, can have good adhesion on concrete. Therefore, the polymer or the carrier can even adhere on the concrete element by itself. An additional fastening of the sealant on the concrete element can therefore be dispensed with. Alternatively, the carrier can also be precoated with the polymer, for example the carrier can therefore be a swelling nonwoven fabric.

The carrier (which is designed to be planar) can comprise an active substance on one or both of its flat sides.

For example, the carrier can comprise active substance on only one of its two flat sides. In this case, on the other flat side which can be oriented facing away from the concrete element, for example, the sealant or the carrier can be provided with additional properties, in particular surface properties, according to the requirements of a particular installation situation. If the carrier has active substance on both flat sides, however, the amount of active substance per unit of area of the carrier can be increased.

It is particularly advantageous when the sealant has a predefined minimum roughness on at least one flat side of the carrier.

Due to the minimum roughness, the bond between the sealant and the concrete element can be improved. In particular, any force-fit and/or form-fit connections which may be present can also be improved by “interlocking” with the concrete element provided with the sealant.

Additionally or alternatively, it can also be provided that the active substance itself bonds with the concrete element. The carrier can also establish a bond with the concrete element, in particular independently of the active substance.

It can also be provided that the sealant includes a preferably water- and/or gas-impermeable covering on at least one flat side of the carrier. In particular, it can be provided that the covering is removably applied on the sealant. In this case, the covering can protect the sealant, in particular during storage until ready for use. For use, the covering can be removed from the sealant, so that the sealing effects of the sealant can be utilized.

The covering can also generate further properties of the sealant, in particular of a flat side of the carrier, in particular depending on the application. For example, the use of a covering which keeps concrete-destroying substances away from the concrete element can further protect the concrete element from concrete aging.

The covering can also have, for example, a predefined minimum gas-impermeability, in particular with respect to radon and/or methane. In other words, the covering can be gas-impermeable, in particular with respect to radon and/or methane.

The production of a sealant according to the invention, comprising a planar, flexible carrier and an active substance, can include the steps of:

a) equipping the carrier with an adhesion promoter, in particular as a dispersion, and/or with a polymer, in particular a liquid dispersion polymer and/or a superabsorbent polymer, and

b) applying the remaining active substance onto the carrier, in particular by rolling or spraying the active substance onto the carrier and/or by immersing and/or impregnating the carrier into or with the remaining active substance.

Therefore, for the purpose of production, the polymer and/or the dispersion can be applied onto the carrier first, so that the subsequently applied, remaining active substance is better fixed on the carrier.

To this end, the active substance can be advantageously liquid at first. After the application, the active substance, in particular the adhesion promoter contained therein, can dry on the carrier.

Alternatively, the active substance can also be initially mixed and then subsequently applied onto the carrier, in particular being rolled on or sprayed on, and/or can be applied onto the carrier via immersion and/or impregnation of the carrier into and/or with the active substance.

To this end, the active substance can also advantageously contain an adhesion promoter. In order to avoid premature curing, the active substance can be kept in motion by means of a mixer. Subsequently, yet another, in particular water- and/or gas-impermeable covering can be applied, preferably removably, onto the sealant, preferably on both sides of the sealant.

The sealant can then be utilized. To this end, the covering can first be removed on one side. The sealant can be applied, via this side, onto a concrete element to be sealed or can be situated on the concrete element to be sealed. The covering can be subsequently removed from the other side. The sealant then protects and seals the concrete element.

The scope of the invention also covers a method for producing a sealed concrete element. According to the invention, to this end,

a) one side of a formwork is equipped with a sealant according to the invention, and

b) concrete is poured against the side of the formwork equipped with the sealant.

The formwork can be removed after the concrete element has cured. The sealant can preferably remain on and/or in the concrete element and/or its surface.

A concrete element which has been produced using formwork technology and sealed with a sealant according to the invention can therefore be fabricated in a particularly easy way.

To this end, it can be provided that the sealant is stapled onto the side of the formwork, in particular being stapled with the aid of a tacker. Tacker clamps can be utilized as the fasteners.

In this case, it is possible to make use of the fact that the sealant can be sufficiently securely fastened on the side of the formwork, on the one hand and, on the other hand, that the stapling is sufficiently loose or can be sufficiently easily removed, so that, when the formwork is removed, the sealant remains on the concrete element and not on the formwork.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a sealant according to the invention;

FIG. 2 shows the sealant with a substance applied to both sides of the carrier;

FIG. 3 shows the sealant according the invention with a covering; and

FIG. 4 shows a formwork having the sealant and concrete attached thereto.

### DETAILED DESCRIPTION OF THE EMBODIMENTS

Further features and advantages of the invention result from the following detailed description of the invention, with reference to the drawings. Further features and advantages of the invention also result from variants of the method according to the invention, and from the claims.

The individual features can be implemented individually, or they can be combined in any possible manner to form variants of the invention.

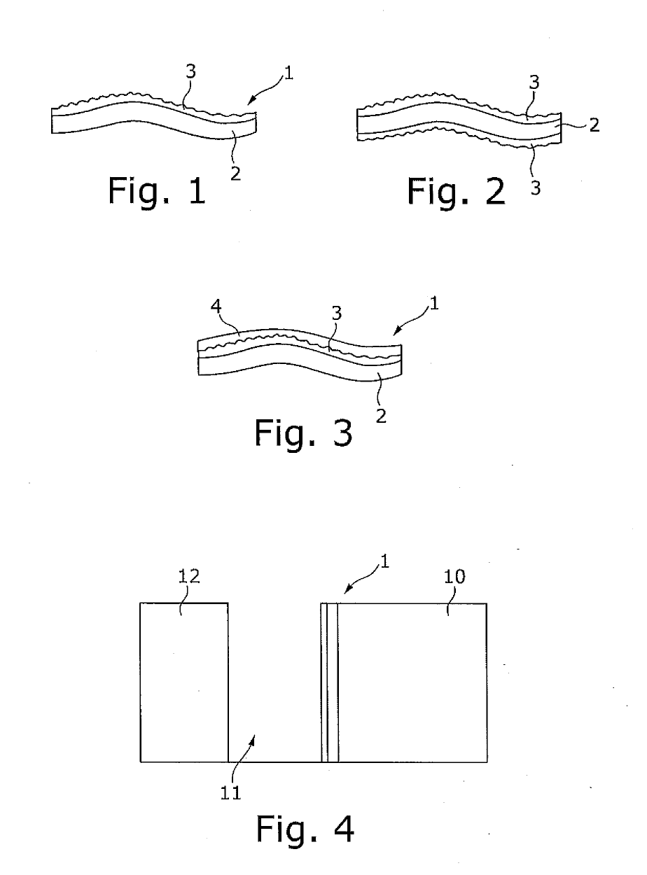

FIG. 1 shows a sealant 1 for a concrete element. The sealant 1 comprises a planar carrier 2. The carrier 2 has an active substance 3, which is applied onto the carrier. The substance 3 is designed to be chemically reactive with water. The carrier 2 is flexible.

Whereas in FIG. 1 the substance 3 is applied to only one side of carrier 2, in FIG. 2 the substance 3 is applied to both sides of the carrier 2.

FIG. 3 shows the sealant 1 of FIG. 1. However, in this case a covering 4 is also applied to the sealant 1. The covering 4 may be water- and/or gas impermeable.

FIG. 4 shows a formwork 10 and a sealant 1 being attached to the 20 formwork 10. The sealant 1 comprises the substance 3, which is facing towards a gap 11. On the other side of the gap 11 there is an existing structure 12, which may for example be a concrete wall. Concrete may be poured into the gap 11 such that concrete is poured against the side of the formwork 10 equipped with the sealant 1.

### Production

Initially, a flexible carrier, for example a geotextile, can be provided as the base for the sealant. Alternatively, a flexible polymer can also be formed in a planar manner, in particular as a type of netting. In this exemplary embodiment, a netting-like or meshed, flexible geotextile can be provided as the carrier, so that the carrier itself is water-permeable.

Subsequent thereto, in order to produce the active substance, an adhesion promoter, in particular in the form of a plastic dispersion, and cement and a liquid dispersion polymer are initially mixed with each other.

The active substance is then applied onto the carrier, for example being sprayed thereon. In particular due to the liquid dispersion polymer and due to the adhesion promoter, the active substance adheres to the carrier, and therefore the active substance can be more easily applied onto the carrier. The water-permeability of the sealant can be adjusted by way of the selection of the mesh width of the carrier and by way of the amounts of active substance applied in specific areas. In this exemplary embodiment, the water-permeability is adjusted in such a way that the sealant is at least slightly water-permeable.

The sealant is subsequently dried until the active substance fixedly adheres on the carrier.

Subsequent thereto, a covering is removably applied onto the sealant, on both sides thereof.

In one alternative variant, the sealant is completely dried and a covering is dispensed with.

### Application

A concrete element to be sealed, for example a concrete element of a wall, can be protected and sealed as follows:

Initially, the covering which may be present is removed on one side. The sealant is placed onto the concrete element in a planar manner and is lightly pressed thereon, if necessary. Due to the flexibility of the carrier, the sealant conforms to the surface of the concrete element. If a concrete element having a large surface area is to be sealed, it suffices to loosely overlap one portion of the sealant with a further portion to be situated next thereto, wherein at least one corresponding portion of the covering is first removed from the other side, if applicable. The portions of the sealant generally do not need to be bonded or adhered to each other, or in any other way sealed with respect to each other. A bond is established between the sealant and the concrete element, in particular by way of a portion of the cement contained in the active substance, and therefore the sealant is permanently fixed on the concrete element.

Subsequent thereto, if applicable, the remainder of the covering is detached or is removed from the sealant.

If a concrete element is to be produced and sealed using formwork technology, then, in one variant of the method, initially at least one side or, depending on the sealing need, multiple sides of the formwork is/are equipped with the sealant. The covering is removed in advance, for this purpose, as needed. The sealant is then stapled to the formwork using tacker clamps. Subsequent thereto, concrete is poured against the formwork and the concrete element is thereby produced. The formwork is removed once the concrete has cured.

According to the findings made by the inventor, it should be noted that the sealant adheres on the concrete and/or interlocks on and in the concrete during the concreting and/or the curing.

If the formwork is subsequently removed, the stapled sealant detaches from the formwork and remains on the concrete element.

The concrete element is initially not hermetically sealed against moisture or water. Instead, water can penetrate up to the component, due to the water-permeability of the sealant. Active substance can also chemically react with the water.

Over the course of time, the sealant passes through essentially three phases, in particular.

At the beginning or in a first phase, the concrete edge zone of the concrete element is improved by means of the carrier. Water cavities and pore structures are at least partially compensated for or are reduced.

In a second phase, active substance or one or multiple components of the active substance is/are transported to the concrete element by the moisture or water flow passing through the sealant, in particular at the beginning. This transport takes place, in particular, at the points at which there is a need for repair, i.e., in particular at cracks, defective spots, and the like. Since the flexible carrier conforms to the concrete element, the situation is avoided in which the active substance or the components is/are rinsed out through a gap that may otherwise be present between the sealant and the concrete element, and the transport path is kept so short that a sufficient amount of the active substance or the components reaches the concrete element.

The liquid dispersion polymer, in particular, swells during the water flow and therefore reduces the water flow through the sealant.

In a third phase and, in particular, in conjunction with the moisture remaining on the concrete element, the transported active substance or the components chemically react on and/or with the concrete element. Depending on the active substance or the components, a sintering takes place, for example, whereby cracks, defective spots, and the like are permanently plugged and, therefore, sealed.

In addition, the carrier reinforces the concrete element on the concrete edge zone and, as a result, additionally minimizes the risk of cracks forming in the future.

Whereas, in the case of a conventional fresh concrete composite film, damage, even local damage such as, for example, a small crack, generally results in an extensive loss of the sealing effect, the sealant according to the invention can still largely ensure a sealing effect or protection of the concrete element. Since the sealing effect is not guaranteed solely by way of the tightness of the sealant itself, but rather also by way of the interplay of the sealant, the transported active substance and the self-healing of the concrete element at damaged areas induced thereby, the sealing effect remains largely retained.

An improved, long-lasting and, in particular, active protection of the concrete element is therefore made possible by the sealant according to the invention.

What is claimed is:

1. A sealant for a concrete element, comprising a planar carrier and an active substance applied onto the carrier, wherein the active substance is designed to be chemically reactive with water, and wherein the carrier is flexible.

2. The sealant as claimed in claim 1, wherein the sealant is at least slightly water-permeable after the production thereof.

3. The sealant as claimed in claim 1, wherein the carrier is selected from the group consisting of a geomembrane, a geotextile, a film, a nonwoven fabric, a PE woven fabric, a PP woven fabric, and a nonwoven fabric-woven fabric combination.

4. The sealant as claimed in claim 1, wherein the active substance comprises at last one of the following: a cement, quartz, a silicate, an ash, a calcium hydroxide, a carbonate, a non-hydrogen carbonate, and a calcium carbonate.

5. The sealant as claimed in claim 1, wherein the active substance contains an adhesion promoter.

6. The sealant as claimed in claim 1, wherein the active substance contains an elasticizer.

7. The sealant as claimed in claim 1, wherein the active substance comprises at least one type of a dispersing phase.

8. The sealant as claimed in claim 1, wherein the active substance comprises a water-swellable polymer.

9. The sealant as claimed in claim 1, wherein the carrier comprises the active substance on one flat side or on both of flat sides.

10. The sealant as claimed in claim 1, wherein the sealant has a predefined minimum roughness on at least one flat side of the carrier.

11. The sealant as claimed in claim 1, wherein the sealant comprises a water- and/or gas-impermeable covering on at least one flat side of the carrier.

12. A method for producing a sealed concrete element, comprising the following steps:
a) equipping one side of a formwork with a sealant as claimed in claim 1, and
b) pouring concrete against the side of the formwork equipped with the sealant.

13. The method as claimed in claim 12, wherein the sealant is stapled onto the side of the formwork.
